(19) United States
(12) Patent Application Publication
(10) Pub. No.: US 2020/0280651 A1
(43) Pub. Date: Sep. 3, 2020

(54) INFORMATION PROCESSING APPARATUS, SYSTEM, CONTROL METHOD, AND NON-TRANSITORY RECORDING MEDIUM

(71) Applicants: Yuusuke Tomura, Kanagawa (JP); Masaaki Kawamura, Kanagawa (JP); Kenichi Yamada, Kanagawa (JP)

(72) Inventors: Yuusuke Tomura, Kanagawa (JP); Masaaki Kawamura, Kanagawa (JP); Kenichi Yamada, Kanagawa (JP)

(73) Assignee: Ricoh Company, Ltd., Tokyo (JP)

(21) Appl. No.: 16/696,112

(22) Filed: Nov. 26, 2019

(30) Foreign Application Priority Data
Feb. 28, 2019 (JP) 2019-036436

(51) Int. Cl. H04N 1/32; H04N 1/333

(52) U.S. Cl. CPC H04N 1/32673; H04N 2201/0094; H04N 1/33361

(57) ABSTRACT

An information processing apparatus includes a first communication device, a second communication device, and circuitry. The first communication device transmits and receives the information to and from another information processing apparatus via a first communication channel. The second communication device transmits and receives the information to and from the another information processing apparatus via a second communication channel. The circuitry resets the first communication device while maintaining communication between the information processing apparatus and the another information processing apparatus via the second communication channel.

### CROSS-REFERENCE TO RELATED APPLICATION

This patent application is based on and claims priority pursuant to 35 U.S.C. § 119(a) to Japanese Patent Application No. 2019-036436 filed on Feb. 28, 2019 in the Japan Patent Office, the entire disclosure of which is hereby incorporated by reference herein.

### BACKGROUND

### Technical Field

The present invention relates to an information processing apparatus, a system, a control method, and a non-transitory recording medium.

### Description of the Related Art

There is an image forming apparatus including a main device (an example of an information processing apparatus) that includes an image forming engine and a control device (an example of an information processing apparatus) that receives input based on user operation and operates the main device. The main device and the control device are communicably connected to each other via a communication channel, and operate independently of each other on different operating systems (OSs). If a failure occurs in the communication between the main device and the control device, the main device and the control device may be rebooted to restore the normal communication state.

The image forming apparatus may include a communication channel for hardware signals between the main device and the control device separately from a communication channel therebetween for software signals. In the event of a failure in the communication between the main device and the control device, a reboot command may be transmitted from the main device to the control device via the communication channel for hardware signals to reboot and restore the image forming apparatus to the normal state.

During the reboot of the image forming apparatus, however, the image forming apparatus is unavailable for use by users, compromising usability.

### SUMMARY

In one embodiment of this invention, there is provided an improved information processing apparatus that includes, for example, a first communication device, a second communication device, and circuitry. The first communication device transmits and receives the information to and from another information processing apparatus via a first communication channel. The second communication device transmits and receives the information to and from the another information processing apparatus via a second communication channel. The circuitry resets the first communication device while maintaining communication between the information processing apparatus and the another information processing apparatus via the second communication channel.

In one embodiment of this invention, there is provided an improved system that includes, for example, the above-described information processing apparatus and the another information processing apparatus.

In one embodiment of this invention, there is provided an improved control method executed by an information processing apparatus. The information processing apparatus includes a first communication device and a second communication device. The first communication device transmits and receives information to and from another information processing apparatus via a first communication channel. The second communication device transmits and receives the information to and from the another information processing apparatus via a second communication channel. The control method includes, for example, resetting the first communication device while maintaining communication between the information processing apparatus and the another information processing apparatus via the second communication channel.

In one embodiment of this invention, there is provided a non-transitory recording medium storing a plurality of instructions which, when executed by one or more processors, cause the processors to perform the above-described control method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a system configuration of an image forming apparatus according to an embodiment of the present invention;

FIG. 2 is a diagram illustrating a hardware configuration of the image forming apparatus of the embodiment;

FIG. 3 is a functional block diagram of a main device and a control device of the image forming apparatus of the embodiment;

FIG. 4 is a flowchart illustrating an exemplary operation of the embodiment performed in the event of a failure in wired communication to restore the wired communication;

FIG. 5 is a flowchart illustrating an exemplary operation of the embodiment performed at start-up of the main device;

FIGS. 6A and 6B are a flowchart illustrating an exemplary operation of the embodiment performed to periodically monitor the occurrence or non-occurrence of a communication failure; and

FIG. 7 is a flowchart illustrating an exemplary operation of the embodiment related to a communication unit resetting process.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. In the drawings illustrating embodiments of the present invention, members or components having the same function or shape will be denoted with the same reference numerals to avoid redundant description.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

An embodiment of the present invention will be described.

An image forming apparatus of an embodiment of the present invention includes a main device and a control device. When wired communication between the main device and the control device fails, a device for communication between the main device and the control device is switched to a wireless communication device. Thereby, parts of the image forming apparatus related to the wired communication are reset and restored while the communication between the main device and the control device is maintained. The parts related to the wired communication are thus reset during the wireless communication between the main device and the control device. Thereby, the parts related to the wired communication are restored without compromising user operability and convenience, and the failure resilience of the image forming apparatus is improved.

A system configuration of the image forming apparatus of the embodiment will be described.

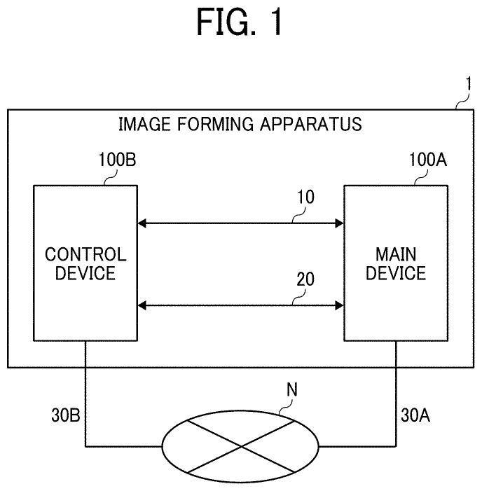

FIG. 1 is a diagram illustrating a system configuration of the image forming apparatus of the embodiment. An image forming apparatus 1 includes a main device 100A (an example of an information processing apparatus) that performs image formation and a control device 100B (an example of an information processing apparatus) that operates the main device 100A. The main device 100A and the control device 100B operate independently of each other on different OSs installed in the main device 100A and the control device 100B. The main device 100A and the control device 100B are communicably connected to each other via a wired communication channel 10 (an example of a first communication channel) through which information is transmitted and received by wire and a wireless communication channel 20 (an example of a second communication channel) through which information is wirelessly transmitted and received. The main device 100A and the control device 100B transmit and receive information to and from each other via the wired communication channel 10 and the wireless communication channel 20.

Further, the main device 100A and the control device 100B are connected to a communication network N via a network communication channel 30A and a network communication channel 30B, respectively, to transmit and receive information to and from each other via the communication network N. Further, each of the main device 100A and the control device 100B is capable of transmitting and receiving information to and from another information processing apparatus connected thereto via the communication network N. The another information processing apparatus connected to the main device 100A or the control device 100B via the communication network N may be a personal computer (PC), a communication server apparatus, or a mobile information terminal, for example. Each of the network communication channels 30A and 30B may be a wired communication channel or a wireless communication channel.

For example, the image forming apparatus 1 may be a multifunction peripheral (MFP) capable of implementing at least two of a plurality of functions such as a copier function, a scanner function, a facsimile machine function, and a printer function, or may be a copier, a printer, or a scanner.

The wired communication channel 10 may be, but is not limited to, a signal line for serial communication or a communication channel conforming to the universal serial bus (USB) standard. Further, the wired communication channel 10 may be a communication channel of a wired local area network (LAN).

The wireless communication channel 20 may be, but is not limited to, a communication channel conforming to the Bluetooth (registered trademark), infrared data association (IrDA), wireless fidelity (WiFi, registered trademark), or near field communication (NFC) standard. Further, the wireless communication channel 20 may be a communication channel of a wireless LAN.

Each of the network communication channels 30A and 30B may be, but is not limited to, a wired LAN, a wireless LAN, or a mobile communication network.

The wired communication channel 10, the wireless communication channel 20, and the network communication channels 30A and 30B may employ any communication method.

A hardware configuration of the image forming apparatus 1 of the embodiment will be described.

A hardware configuration of the main device 100A will first be described.

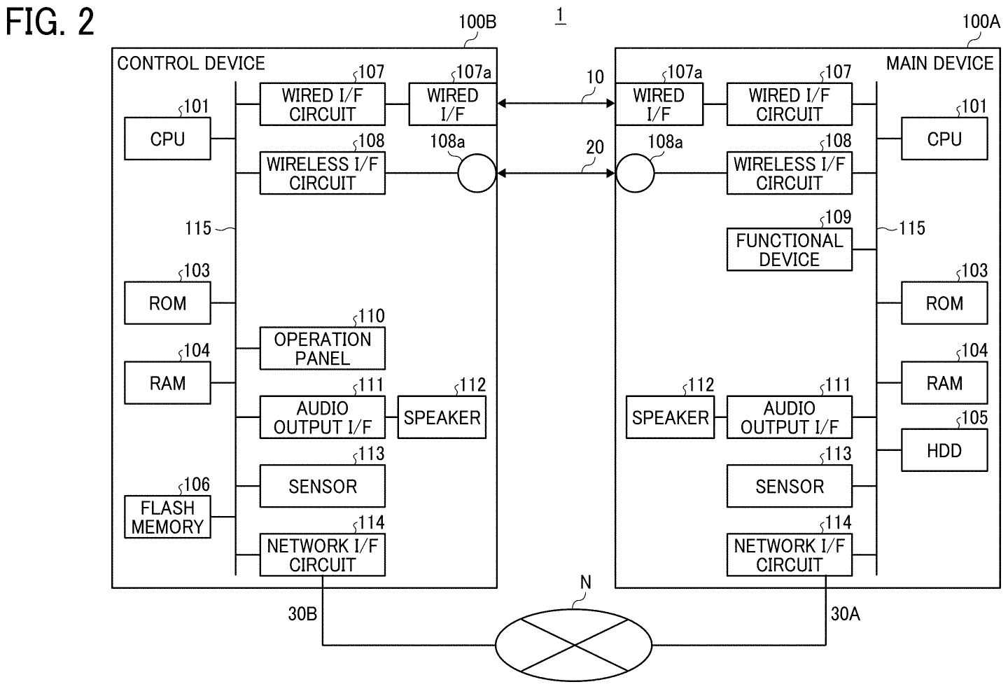

FIG. 2 is a diagram illustrating a hardware configuration of the image forming apparatus 1 of the embodiment. The main device 100A includes a central processing unit (CPU) 101, a read only memory (ROM) 103, a random access memory (RAM) 104, a hard disk drive (HDD) 105, a wired interface (I/F) circuit 107 (an example of a first communication interface circuit), a wireless I/F circuit 108 (an example of a second communication interface circuit), a functional device 109, an audio output I/F 111, a sensor 113, and a network I/F circuit 114, which are connected to each other via a bus 115 included in the main device 100A. The main device 100A is a computer.

The CPU 101 performs overall control of the main device 100A. The ROM 103 is a nonvolatile storage device that stores programs and data for use in controlling the main device 100A. The RAM 104 is a volatile storage device used as a work memory by the CPU 101 when executing a control program. The HDD 105 is a nonvolatile storage device that stores various control programs and application programs. The CPU 101 reads a predetermined program from the ROM 103 or the HDD 105 and deploys and executes the program in the RAM 104 to implement various functions.

The wired I/F circuit 107 and a wired UF 107a serve as an interface for communicably connecting the main device 100A to the control device 100B by wire, and communicate with the control device 100B directly (i.e., on a one-to-one basis) through the wired communication channel 10. The wired I/F circuit 107 is an integrated circuit (IC) for driving the wired I/F 107a, which is a connection port to be connected to a wire cable forming the wired communication channel 10. The wired I/F circuit 107 generates a signal related to information transmitted and received to and from the control device 100B via the wired communication channel 10.

The wireless I/F circuit 108 serves as an interface for communicably and wirelessly connecting the main device 100A to the control device 100B, and forms a circuit module that communicates with the control device 100B directly (i.e., on a one-to-one basis) through the wireless communication channel 20 via an antenna 108a. The wireless I/F circuit 108 generates a signal related to information transmitted and received to and from the control device 100B via the wireless communication channel 20.

The functional device 109 implements various functions depending on the type of the apparatus including the functional device 109. In the present example, the apparatus including the functional device 109 is the image forming apparatus 1. In this case, the functional device 109 is an image forming engine, for example, implementing a function such as a black-and-white plotter, a drum color plotter, a scanner, or a facsimile unit, for example.

The audio output 111 is a circuit that performs processing such as output of an audio signal to a speaker 112 under the control of the CPU 101. The speaker 112 is a built-in circuit that converts an electrical signal into a physical vibration to generate sounds such as music and voice.

The sensor 113 is a device that detects whether the image forming apparatus 1 is being used. For example, the sensor 113 is implemented as an illuminance sensor that detects the brightness around the main device 100A or a human sensor that detects a human body by detecting infrared light present around the main device 100A.

The network I/F circuit 114 serves as an interface for performing data communication via the communication network N such as the Internet.

A hardware configuration of the control device 100B will now be described.

The control device 100B is a device that receives input based on user operation and operates the main device 100A. The control device 100B may be a dedicated device for operating the main device 100A, or may be a general-purpose device used by a user, such as a smartphone or a tablet terminal. The control device 100B is a computer.

The following description of the control device 100B will focus on differences of the control device 100B from the main device 100A, and description of similarities of the control device 100B to the main device 100A will be omitted where appropriate.

The control device 100B is different from the main device 100A in not including the functional device 109 and the HDD 105 but including a flash memory 106 and an operation panel 110.

The flash memory 106 is a nonvolatile storage device that stores various control programs and application programs. The CPU 101 reads a predetermined program from the ROM 103 or the flash memory 106 and deploys and executes the program in the RAM 104 to implement various functions.

The operation panel 110 is a device that displays information such as a setting value according to the function implemented by the functional device 109 of the main device 100A and receives input of information such as a setting value. In the present example, the apparatus including the functional device 109 is the image forming apparatus 1. In this case, the operation panel 110 includes a panel display, such as a touch panel, that displays a current setting value or a selection screen, for example, and receives input from the user such as a. setting value of an image formation condition (e.g., density setting condition). The operation panel 110 may also include hardware keys such as numeric keys for receiving a setting value of an image formation condition (e.g., density setting condition) and a start key for receiving an instruction to start a copying operation. Further, in the event of a failure in the wired or wireless communication between the main device 100A and the control device 100B, the operation panel 110 displays a message notifying the occurrence of the failure to send out the message.

The control device 100B may further include a keyboard, a mouse, a microphone capable of receiving audio input, and a camera capable of receiving gesture input, for example, as devices for receiving the input from the user.

The sensor 113 is a device that detects whether the image forming apparatus 1 is being used. For example, the sensor 113 is implemented as an illuminance sensor that detects the brightness around the control device 100B or a human sensor that detects a human body by detecting infrared light present around the control device 100B.

As well as the operation panel 110 included in the control device 100B, another operation panel may be included in the main device 100A operated by the control device 100B. In this case, the operation panel included in the main device 100A may display information such as a setting value according to the function implemented by the functional device 109 and may receive input of information such as a setting value.

Functional blocks of the image forming apparatus 1 will be described.

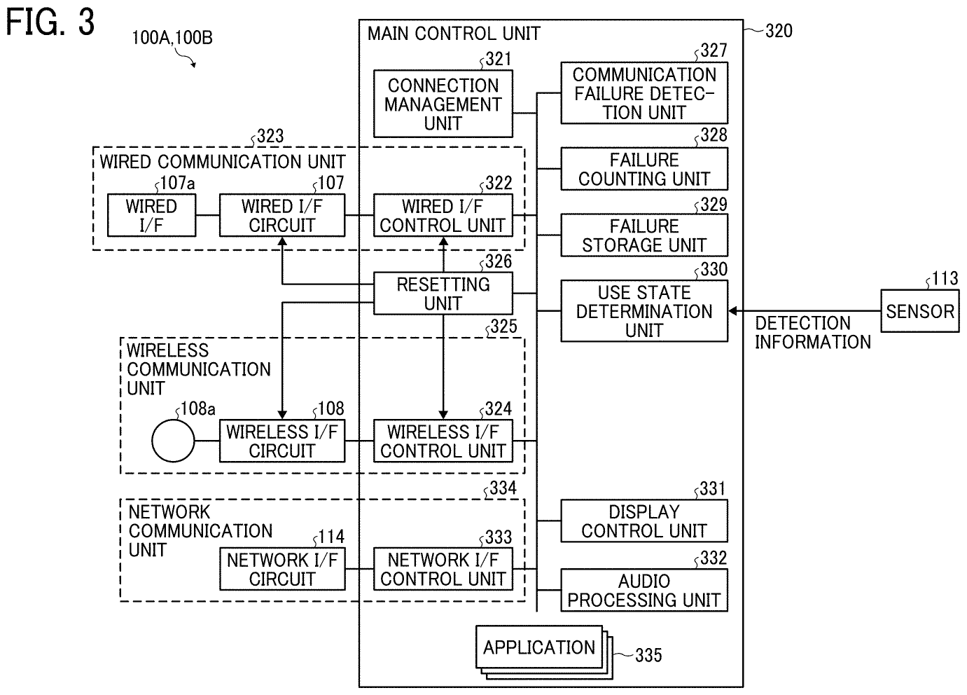

FIG. 3 is a functional block diagram of the main device 100A and the control device 100B of the image forming apparatus 1 of the embodiment.

Each of the main device 100A and the control device 100B includes a main control unit 320. The main control unit 320 includes a connection management unit 321, a wired I/F control unit 322 (an example of a first communication controller), a wireless I/F control unit 324 (an example of a second communication controller), a resetting unit 326, a communication failure detection unit 327, a failure counting unit 328, a failure storage unit 329, a use state determination unit 330, a display control unit 331, an audio processing unit 332, and a network I/F control unit 333.

In the main device 100A, the main control unit 320 is implemented by a program read from the ROM 103 or the HDD 105 and deployed and executed in the RAM 104 by the CPU 101 of the main device 100A.

In the control device 100B, the main control unit 320 is implemented by a program read from the ROM 103 or the flash memory 106 and deployed and executed in the RAM 104 by the CPU 101 of the control device 100B.

The connection management unit 321 manages connection by determining whether to communicate with a communication target device (i.e., the control device 100B or the main device 100A) via the wired communication channel 10 or via the wireless communication channel 20. The connection management unit 321 switches, as necessary, between a wired communication unit 323 (an example of a first communication device) and a wireless communication unit 325 (an example of a second communication device) as a communication unit that transmits and receives information to and from the communication target device. The connection management unit 321 may execute wired communication and wireless communication at the same time.

The wired I/F control unit 322, which controls the operation of the wired I/F circuit 107, is a software module executed by the CPU 101. The wired I/F control unit 322, the wired I/F circuit 107, and the wired I/F 107a form the wired communication unit 323, which transmits and receives information via the wired communication channel 10.

The wireless I/F control unit 324, which controls the operation of the wireless I/F circuit 108, is a software module executed by the CPU 101. The wireless I/F control unit 324, the wireless circuit 108, and the antenna 108a form the wireless communication unit 325, which transmits and receives information via the wireless communication channel 20.

The resetting unit 326 executes a resetting process of resetting the wired communication unit 323 or the wireless communication unit 325. To reset the wired communication unit 323, the resetting unit 326 resets both the wired I/F control unit 322 and the wired I/F circuit 107. To reset the wireless communication unit 325, the resetting unit 326 resets both the wireless I/F control unit 324 and the wireless I/F circuit 108.

Herein, resetting the wired I/F control unit 322 refers to terminating and restarting the wired I/F control unit 322, which is a software module. With the wired I/F control unit 322 reset, various variables stored in the RAM 104 under the management of the wired I/F control unit 322 are returned to initial values. Further, resetting the wired I/F circuit 107 refers to initializing the electrical state inside the wired I/F circuit 107. The respective resetting processes of the wireless I/F control unit 324 and the wireless I/F circuit 108 are similar to the above-described resetting processes of the wired I/F control unit 322 and the wired I/F circuit 107.

The resetting unit 326 is capable of independently executing the resetting process of the wired communication unit 323 and the resetting process of the wireless communication unit 325. The resetting unit 326 is therefore capable of executing the resetting process of the wired communication unit 323 while the wireless communication is maintained between the main device 100A and the control device 100B via the wireless communication channel 20. Similarly, the resetting unit 326 is capable of executing the resetting process of the wireless communication unit 325 while the wired communication is maintained between the main device 100A and the control device 100B via the wired communication channel 10.

The resetting unit 326 may be included in one or both of the main device 100A and the control device 100B, Further, as the resetting unit 326, a unit that resets the wired communication unit 323 and a unit that resets the wireless communication unit 325 may be implemented by separate independent control programs.

The communication failure detection unit 327 detects a communication failure occurring in the wired communication via the wired communication channel 10 or in the wireless communication via the wireless communication channel 20.

Specifically, the wired I/F control unit 322 of the wired communication unit 323 periodically outputs a signal indicating normal operation to the communication failure detection unit 327. When the signal is not received for at least a predetermined time since the last reception of the signal from the wired I/F control unit 322, the communication failure detection unit 327 detects a communication failure related to the wired communication channel 10 due to a failure of the wired I/F control unit 322. The communication failure detection unit 327 similarly detects a communication failure related to the wireless communication channel 20 due to a failure of the wireless I/F control unit 324 of the wireless communication unit 325.

Further, when the wired communication unit 323 transmits a predetermined signal to the communication target device and a response signal to the transmitted signal (e.g., acknowledgement (ACK) response in transmission control protocol/internet protocol (TCP/IP) communication) is not received for at least a predetermined time since the transmission of the predetermined signal, the communication failure detection unit 327 detects a communication failure related to the wired communication channel 10 due to some failure. The communication failure detection unit 327 similarly detects a communication failure related to the wireless communication channel 20 due to some failure.

The method of detecting the communication failure is not limited to the above-described method. The communication failure detection unit 327 may be included in one or both of the main device 100A and the control device 100B. Further, as the communication failure detection unit 327, a unit that detects the communication failure related to the wired communication channel 10 and a unit that detects the communication failure related to the wireless communication channel 20 may be implemented by separate independent control programs. The communication failure detection unit 327 detects both a communication failure due to a hardware failure and a communication failure due to a software failure.

The failure counting unit 328 counts the number of occurrences of the communication failure related to the wired communication channel 10 detected by the communication failure detection unit 327 and the number of occurrences of the communication failure related to the wireless communication channel 20 detected by the communication failure detection unit 327.

The failure storage unit 329 stores the number of occurrences of the communication failure related to the wired communication channel 10 counted by the failure counting unit 328 and the number of occurrences of the communication failure related to the wireless communication channel 20 counted by the failure counting unit 328. The failure storage unit 329 is implemented by a nonvolatile storage device. The failure storage unit 329 may further store the date and time of occurrence of the communication failure related to the wired communication channel 10 or the wireless communication channel 20.

The failure counting unit 328 and the failure storage unit 329 may be included in one or both of the main device 100A and the control device 100B.

Based on information such as detection information received from the sensor 113, the use state determination unit 330 determines whether the main device 100A, the control device 100B, or the image forming apparatus 1 is currently being used. For example, if the sensor 113 is an illuminance sensor that detects the brightness around the main device 100A or the control device 100B, and if the brightness detected by the illuminance sensor is equal to or greater than a predetermined value, the use state determination unit 330 determines that the main device 100A, the control device 100B, or the image forming apparatus 1 is currently being used. If the sensor 113 is a human sensor that detects, based on infrared light, for example, a human body present near the main device 100A or the control device 100B, and if a human body is detected by the human sensor, the use state determination unit 330 determines that the main device 100A, the control device 100B, or the image forming apparatus 1 is currently being used. Further, when the operation panel 110 is not being operated by the user, the use state determination unit 330 may determine that the main device 100A, the control device 100B, or the image forming apparatus 1 is not being used by the user.

The use state determination unit 330 and the sensor 113 may be included in one or both of the main device 100A and the control device 100B. If the sensor 113 is included in both the main device 100A and the control device 100B, the main device 100A and the control device 100B may include different sensors as the sensor 113. For example, the main device 100A and the control device 100B may include a human sensor and an illuminance sensor, respectively, as the sensor 113 such that the main device 100A and the control device 100B detect the use state of the main device 100A, the control device 100B, or the image forming apparatus 1 by employing different methods.

The display control unit 331 controls the display state of the operation panel 110.

The audio processing unit 332 processes the sound to be output from the speaker 112 via the audio output I/F 111.

The network I/F control unit 333, which controls the operation of the network I/F circuit 114, is a software module executed by the CPU 101. The network I/F control unit 333 and the network I/F circuit 114 form a network communication unit 334.

The display control unit 331, the audio processing unit 332, and the network communication unit 334 function as a failure notification unit. In the event of a failure unlikely to be resolved by the resetting process, the failure notification unit sends out a message notifying the occurrence of the failure.

An application 335 includes a user interface to display a screen on the operation panel 110 and receive operation settings, for example, from the user via the operation panel 110. The application 335 of the main device 100A may provide a service using a function of the main device 100A, such as the copier function, the scanner function, the facsimile machine function, or the printer function.

Various operations of the image forming apparatus 1 will be described based on flowcharts. The following description will be given of exemplary operations of the main device 100A, but the description also applies to operations of the control device 100B. Further, the following description will be given of exemplary operations performed when the communication failure occurs in the wired communication channel 10 on the assumption that the communication between the main device 100A and the control device 100B is normally performed via the wired communication channel 10. However, the wireless communication may be performed instead of the wired communication as the communication between the main device 100A and the control device 100B.

An operation of restoring the wired communication will be described.

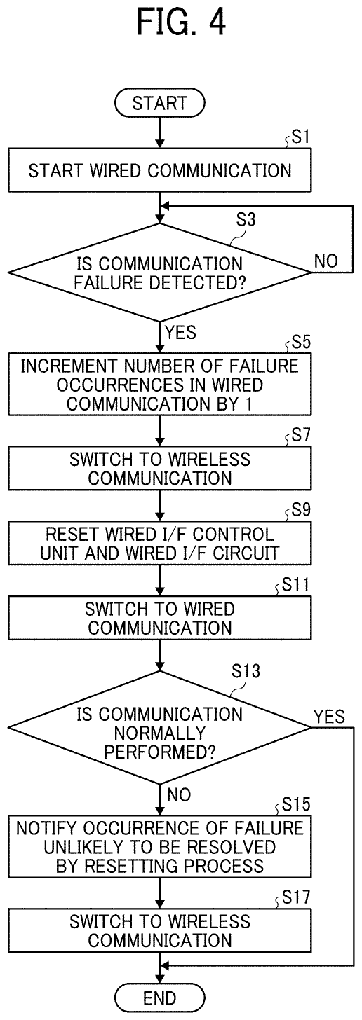

FIG. 4 is a flowchart illustrating an operation performed in the event of a failure in the wired communication to restore the wired communication. In the present example, when a failure occurs in the wired communication, the execution of the resetting process is limited to the wired communication unit 323.

At step S1, the main device 100A starts the wired communication with the control device 100a. That is, the connection management unit 321 commands the wired I/F control unit 322 to establish the wired communication with the control device 100B via the wired communication channel 10. Based on this command, the wired I/F control unit 322 controls the wired I/F circuit 107 to establish the wired communication with the control device 100B via the wired communication channel 10. With the start of the wired communication with the control device 100B via the wired communication channel 10, the process of step S3 is executed.

The communication failure detection unit 327 constantly monitors the occurrence or non-occurrence of the communication failure. At step S3, if the communication failure detection unit 327 detects the communication failure related to the wired communication channel 10 used in the communication (YES at step S3), the process of step S5 is executed.

At step S5, the failure counting unit 328 acquires from the communication failure detection unit 327 a signal indicating that the communication failure has been detected. The failure counting unit 328 then reads from the failure storage unit 329 the number of occurrences of the communication failure related to the wired communication channel 10, increments the number of occurrences of the communication failure by one, and stores the incremented number of occurrences of the communication failure in the failure storage unit 329.

At step S7, the connection management unit 321 acquires from the communication failure detection unit 327 the signal indicating that the communication failure has been detected. The connection management unit 321 then switches from the wired communication unit 323 to the wireless communication unit 325 as the communication unit that transmits and receives information to and from the control device 100B. That is, the connection management unit 321 commands the wired I/F control unit 322 to terminate the wired communication with the control device 100B via the wired communication channel 10, and commands the wireless I/F control unit 324 to establish the wireless communication with the control device 100B via the wireless communication channel 20. Then, the wireless communication with the control device 100B starts, and the process of step S9 is executed.

At step S9, the resetting unit 326 acquires from the communication failure detection unit 327 the signal indicating that the communication failure has been detected. After establishment of the wireless communication, i.e., after acquisition from the connection management unit 321 a signal indicating that the wireless communication has been established, the resetting unit 326 resets the wired communication unit 323. That is, the resetting unit 326 resets the wired I/F control unit 322 and the wired I/F circuit 107.

At step S11, the connection management unit 321 acquires from the resetting unit 326 a signal indicating that the resetting process of the wired communication unit 323 has been completed. The connection management unit 321 then switches from the wireless communication unit 325 to the wired communication unit 323 as the communication unit that communicates with the control device 100B. That is, the connection management unit 321 commands the wireless I/F control unit 324 to terminate the wireless communication with the control device 100B via the wireless communication channel 20, and commands the wired I/F control unit 322 to establish the wired communication with the control device 100B via the wired communication channel 10. Then, the wired communication with the control device 100B starts, and the process of step S13 is executed.

At step S13, the communication failure detection unit 327 detects the occurrence or non-occurrence of the communication failure related to the wired communication channel 10. if the communication is normally performed, i.e., if the communication failure is not detected (YES at step S13), the procedure is completed. If the communication is not normally performed, i.e., if the communication failure is detected (NO at step S13), the processes of steps S15 and S17 are executed.

At step S15, based on a detection result received from the communication failure detection unit 327, the main device 100A sends out a message notifying that a failure unlikely to be resolved by resetting the wired communication unit 323 has occurred in the wired communication unit 323. As a method of sending out the message notifying the occurrence of such a failure, the message notifying the occurrence of the failure may be displayed on the operation panel 110 of the main device 100A or output as sound from the speaker 112 of the main device 100A. Alternatively, the occurrence of the failure may be notified to the control device 100B via the wireless communication channel 20 to display the message notifying the occurrence of the failure on the operation panel 110 of the control device 100B or output the message as sound from the speaker 112 of the control device 100B. As still another method, the occurrence of the failure may be notified to a PC of the user or a maintenance technician or a server apparatus, which is communicably connected to the image forming apparatus 1 via the communication network N. Further, when the main device 100A is connected to the PC of the maintenance technician via the wireless communication channel 20, the main device 100A may notify the PC of the maintenance technician of the occurrence of the failure via the wireless communication channel 20.

At step S17, based on the detection result from the communication failure detection unit 327 notifying that the communication failure has been detected, the connection management unit 321 switches from the wired communication unit 323 to the wireless communication unit 325 as the communication unit that communicates with the control device 100B. This process is similar to that of step S7. After switching to the wireless communication unit 325 as the communication unit that communicates with the control device 100B, the connection management unit 321 maintains the wireless communication until an instruction from the user or the maintenance technician to switch the communication to the wired communication is acquired via the operation panel 110 or the corresponding communication channel.

According to the present embodiment, when a failure occurs in the wired communication with the control device 100B, the resetting process is executed specifically on the wired communication unit 323 instead of rebooting the entirety of the main device 100A and the control device 100B. In the present example, when a failure occurs in the wired communication, the communication with the control device 100B is switched to the wireless communication via the wireless communication channel 20 to maintain the communication between the main device 100A and the control device 100B. Even if a failure occurs in the communication between the main device 100A and the control device 100B, therefore, the user is able to continue ongoing work with the image forming apparatus 1, without compromise of operability and convenience. Further, the wired communication unit 323 and the wireless communication unit 325 are configured to be reset independently of each other, enabling the wired communication unit 323 to be reset while the wireless communication is maintained.

If a failure occurs in the wired communication between the main device 100A and the control device 100B owing to a failure of the wired communication unit 323 caused by unintended noise, for example, the resetting process is executed specifically on the wired communication unit 323, as described above, to restore the wired communication.

If the wired communication fails owing to a failure of the CPU 101 of the main device 100A or the control device 100B caused by some reason, the wired communication may not be restored by the resetting process of the wired communication unit 323 executed by the resetting unit 326. In such a case, the message notifying the occurrence of the failure unlikely to be resolved by resetting the wired communication unit 323 is sent out by some method, as described above in step S15.

For example, if the failure of the CPU 101 of the main device 100A is not serious and thus the CPU 101 of the main device 100A is able to send out a message, the display control unit 331 may control the operation panel 110 to display the message notifying the occurrence of the failure, and the audio processing unit 332 may perform audio processing to output from the speaker 112 an audio message notifying the occurrence of the failure. Further, the wireless I/F control unit 324 of the main device 100A may transmit a request to the control device 100B (i.e., the communication target device) via the wireless communication channel 20 to display the message notifying the occurrence of the failure on the operation panel 110 of the control device 100B or to output the audio message notifying the occurrence of the failure from the speaker 112. Further, the network I/F control unit 333 of the main device 100A may transmit the message notifying the occurrence of the failure to the PC of the user or the maintenance technician or the server apparatus connected to the image forming apparatus 1 via the communication network N.

For example, if the failure of the CPU 101 of the main device 100A is serious and thus the CPU 101 of the main device 100A is unable to send out a message, the control device 100B (i.e., the communication target device) having detected the communication failure may autonomously send out a message with one of the above-described methods to notify that the failure unlikely to be resolved by resetting the wired communication unit 323 of the control device 100B has occurred in the image forming apparatus 1.

The main device 100A may include a sub-CPU that executes auxiliary control of the main device 100A in the event of a failure of the CPU 101 of the main device 100A. In this case, if the failure of the CPU 101 of the main device 100A is serious and thus the CPU 101 of the main device 100A is unable to send out a message, the sub-CPU may send out a message with one of the above-described methods to notify that the failure unlikely to be resolved by resetting the wired communication unit 323 has occurred.

An operation performed at start-up time will be described.

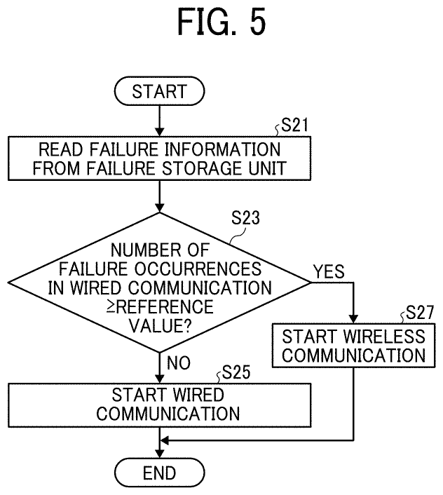

FIG. 5 is a flowchart illustrating an exemplary operation performed at start-up of the main device 100A. In the present example, the wired communication is normally performed. The communication at start-up of the main device 100A, however, is switched between the wired communication and the wireless communication depending on the number of past occurrences of the communication failure related to the wired communication channel 10. Specifically, when the number of occurrences of the communication failure in the wired communication channel 10 reaches a predetermined value, the wireless communication unit 325 is set as the communication unit that transmits and receives information to and from the control device 100B at the next start-up of the main device 100A.

At step S21, the connection management unit 321 reads from the failure storage unit 329 failure information, i.e., the number of past occurrences of the communication failure in the wired communication channel 10.

At step S23, the connection management unit 321 determines whether the number of occurrences of the failure in the wired communication is equal to or greater than a reference value. If the number of occurrences of the failure in the wired communication is less than the reference value (NO at step S23), the process of step S25 is executed. If the number of occurrences of the failure in the wired communication is equal to or greater than the reference value (YES at step S23), the process of step S27 is executed.

At step S25, the connection management unit 321 commands the wired I/F control unit 322 to start the wired communication.

At step S27, the connection management unit 321 commands the wireless I/F control unit 324 to start the wireless communication.

In the present example, when the number of occurrences of the failure in the wired communication is equal to or greater than a predetermined value, the connection management unit 321 of the main device 100A sets the wireless communication unit 325 as the communication unit that communicates with the control device 100B at the start-up of the main device 100A.

If the communication fails owing to a failure of a part of the main device 100A related to the wired communication, the wired communication may not be started when the communication with the wired communication unit 323 is attempted at start-up of the main device 100A. If the main device 100A is configured to start the wired communication preferentially over the wireless communication even in such a case, an operation of switching to the wireless communication takes place after the attempt to start the wired communication, resulting in loss of time until the image forming apparatus 1 is brought back to the normal usable state. According to the present example, on the other hand, when the failure of the wired communication frequently occurs, the main device 100A is set to start communication with wireless connection at start-up time, thereby preventing the above-described loss of time and improving the user convenience.

The failure storage unit 329 may store the date and time of each occurrence of the communication failure. In this case, when the number of occurrences of the failure in the wired communication reaches a predetermined value during a predetermined period of time, the connection management unit 321 may set the wireless communication unit 325 as the communication unit that communicates with the control device 100B at start-up of the main device 100A.

As described above, according to the present embodiment, the number of occurrences of the failure in the wired communication is counted. Then, when the number of occurrences of the failure in the wired communication reaches a predetermined value, the communication at the next start-up of the main device 100A is switched to the wireless communication. The present embodiment thereby prevents a failure such as the disruption of communication due to the occurrence of a failure in the wired communication.

A periodic monitoring operation will be described.

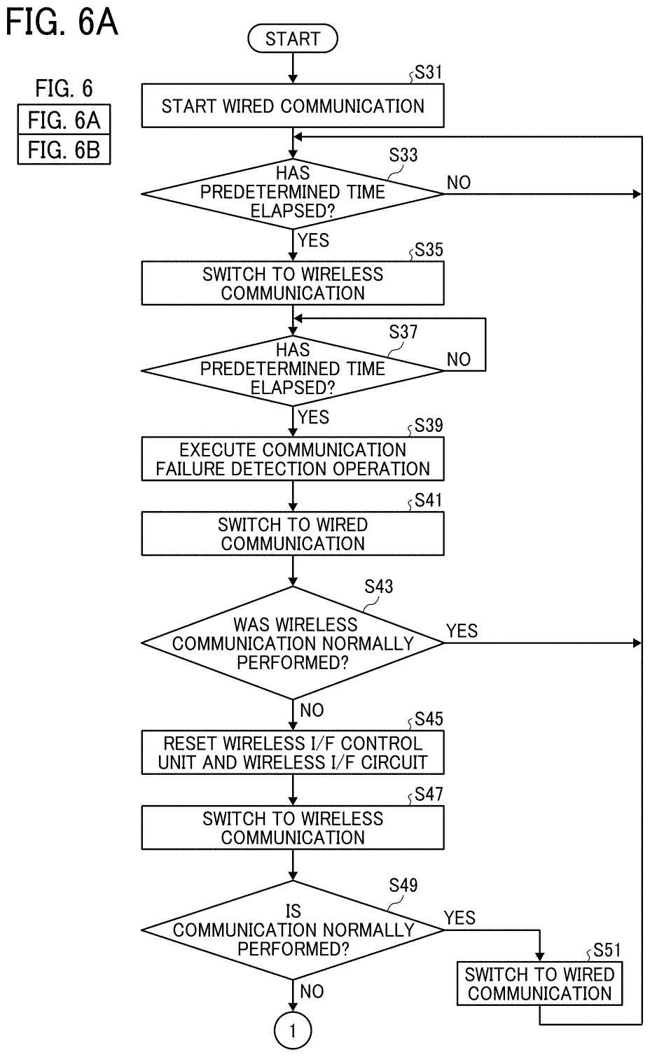

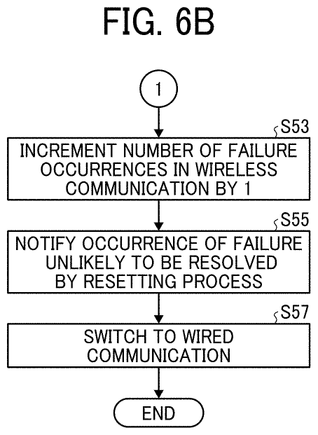

FIGS. 6A and 6B are a flowchart illustrating an exemplary operation of periodically monitoring the occurrence or non-occurrence of the communication failure. In the present example, the wired communication is normally performed. The connection management unit 321, however, temporarily switches from the wired communication unit 323 to the wireless communication unit 325 at a predetermined time as the communication unit that transmits and receives information to and from the control device 100B. The wired communication is thus switched to the wireless communication at a predetermined time to check if parts related to the wireless communication normally operate, to thereby reliably execute the wireless communication in the event of a failure in the wired communication.

At step S31, the main device 100A starts the wired communication with the control device 100B.

At step S33, the connection management unit 321 checks if a predetermined time has elapsed since the start of the wired communication. If the predetermined time has elapsed since the start of the wired communication (YES at step S33), the process of step S35 is executed.

At step S35, the connection management unit 321 switches from the wired communication unit 323 to the wireless communication unit 325 as the communication unit that communicates with the control device 100B. Thereby, the wireless communication with the control device 100B starts.

At step S37, the connection management unit 321 checks if a predetermined time has elapsed since the start of the wireless communication. If the predetermined time has elapsed since the start of the wireless communication (YES at step S37), the process of step S39 is executed.

At step S39, the communication failure detection unit 327 executes a communication failure detection operation to detect the occurrence or non-occurrence of the communication failure related to the wireless communication channel 20. Executing the communication failure detection operation immediately after the switch from the wired communication unit 323 to the wireless communication unit 325 may result in erroneous detection. Therefore, the occurrence or non-occurrence of the communication failure is detected after it is determined at step S37 that the predetermined time has elapsed since the start of the wireless communication.

At step S41, the connection management unit 321 switches from the wireless communication unit 325 to the wired communication unit 323 as the communication unit that communicates with the control device 100B.

At step S43, it is determined whether normal communication is detected as a result of the communication failure detection operation executed by the communication failure detection unit 327 at step S39. If the normal communication is detected (YES at step S43), the process of step S33 is executed. If the normal communication is not detected (NO at step S43), the processes of step S45 and the subsequent steps are executed.

At step S45, the resetting unit 326 acquires from the communication failure detection unit 327 a signal indicating that the communication failure has been detected. After establishment of the wired communication, i.e., after acquisition from the connection management unit 321 a signal indicating that the wired communication has been established, the resetting unit 326 resets the wireless communication unit 325. That is, the resetting unit 326 resets the wireless I/F control unit 324 and the wireless I/F circuit 108. The wireless communication unit 325 is thus reset after the establishment of the wired communication. Even during the resetting process, therefore, the main device 100A and the control device 100B continue to communicate with each other by wire. Thereby, the image forming apparatus 1 is prevented from falling into an unusable state.

At step S47, the connection management unit 321 acquires from the resetting unit 326 a signal indicating that the resetting process of the wireless communication unit 325 has been completed. The connection management unit 321 then switches from the wired communication unit 323 to the wireless communication unit 325 as the communication unit that communicates with the control device 100B.

At step S49, the communication failure detection unit 327 detects the occurrence or non-occurrence of the communication failure related to the wireless communication channel 20. If the normal communication is detected (YES at step S49), the process of step S51 is executed. If the normal communication is not detected (NO at step S49), the processes of step S53 and the subsequent steps are executed.

At step S51, the connection management unit 321 switches from the wireless communication unit 325 to the wired communication unit 323 as the communication unit that communicates with the control device 100B.

At step S53, the failure counting unit 328 acquires from the communication failure detection unit 327 the signal indicating that the communication failure has been detected. The failure counting unit 328 then reads from the failure storage unit 329 the number of occurrences of the communication failure related to the wired communication channel 10, increments the number of occurrences of the communication failure by one, and stores the incremented number of occurrences of the communication failure in the failure storage unit 329.

At step S55, based on a detection result received from the communication failure detection unit 327, the main device 100A sends out a message notifying that a failure unlikely to be resolved by resetting the wireless communication unit 325 has occurred in the wireless communication unit 325.

At step S57, based on the detection result received from the communication failure detection unit 327, the connection management unit 321 switches from the wireless communication unit 325 to the wired communication unit 323 as the communication unit that communicates with the control device 100B.

When the communication failure occurs in the wired communication, the communication is switched to the wireless communication, as illustrated in the flowchart of FIG. 4, to maintain the communication with the control device 100B. To maintain the communication with the control device 100B in this case, normal operation of the wireless communication is expected.

In the present example, the communication unit that communicates with the control device 100B is temporarily switched from the wired communication unit 323 to the wireless communication unit 325 after the lapse of a predetermined time since the start of the wired communication, regardless of the occurrence or non-occurrence of the communication failure, to check if the communication failure occurs in the wireless communication. Then, if the communication failure occurs in the wireless communication, the process of resetting the wireless communication unit 325 is executed. Whether the parts related to the wireless communication normally operate is thus checked at a predetermined time to ensure reliable execution of the wireless communication in the event of a failure in the wired communication. The image forming apparatus 1 is thereby prevented from falling into the unusable state, improving the user convenience.

Whether the parts related to the wireless communication normally operate may not necessarily be checked at the above-described time. For example, whether the parts related to the wireless communication normally operate may be checked when a preset period of time elapses, when a preset time arrives, when a command to check whether the parts related to the wireless communication normally operate is input from outside the image forming apparatus 1, at another predetermined time, or at regular intervals.

A description will be given of the time at which the resetting process is executed.

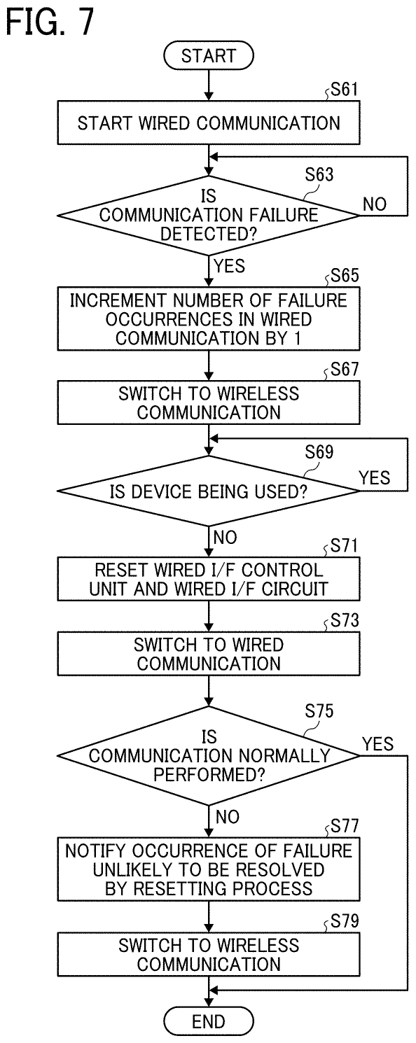

FIG. 7 is a flowchart illustrating an exemplary operation related to a communication unit resetting process. In the present example, when the main device 100A is not being used, the resetting unit 326 resets the communication unit that should be reset.

The processes of steps S61 to S67 in FIG. 7 are similar to those of steps S1 to S7 in FIG. 4, and thus description thereof will be omitted.

At step S69, based on information such as the detection information received from the sensor 113, the use state determination unit 330 determines whether the main device 100A is being used by the user.

Herein, if the sensor 113 is an illuminance sensor that detects the brightness around the main device 100A, and if the illuminance output by the illuminance sensor is less than a predetermined value, the use state determination unit 330 determines that the main device 100A is not being used by the user. If the sensor 113 is a human sensor that detects, based on infrared light, for example, a human body present near the main device 100A, and if no human body is detected by the human sensor, the use state determination unit 330 determines that the main device 100A is not being used by the user. Further, when the operation panel 110 of the main device 100A is not being operated by the user, the use state determination unit 330 may determine that the main device 100A is not being used by the user.

If it is determined that the main device 100A is not being used (NO at step S69), the resetting process of step S71 is executed based on a signal from the use state determination unit 330 indicating that the resetting process is executable.

The processes of steps S71 to S79 in FIG. 7 are similar to those of steps S9 to S17 in FIG. 4, and thus description thereof will be omitted.

The process at step S73 of switching from the wireless communication to the wired communication takes a certain time. According to the present example, the process of switching from the wireless communication to the wired communication is executed when the image forming apparatus 1 is not being used by the user. Thereby, a communication disruption time during the use of the image forming apparatus 1 is minimized, improving the user convenience. Even if a failure occurs in the wired communication, the communication between the main device 100A and the control device 100B is maintained by the wireless communication, as in step S67, and thus the restoration of the wired communication is not a time-critical process. The wired communication is therefore restored when the image forming apparatus 1 is not being used by the user, thereby attaining the above-described effects.

The above description of the embodiment has been given of an example in which the main device 100A that performs image formation is a host device operable by the control device 100B. The host device operable by the control device 100B, however, is not limited to the main device 100A of the image forming apparatus 1. The present invention is also applicable to other devices operable by the control device 100B.

The present invention is applicable not only to devices such as a main device of an image forming apparatus and a control device that operates the main device but also to information processing apparatuses such as a PC and another PC.

The information processing apparatuses to which the present invention is applied are not limited to the main device 100A and the control device 100B of the image forming apparatus 1, and may be any information processing apparatuses with a communication function. The information processing apparatuses to which the present invention is applied may include a projector (PJ), an interactive whiteboard (IWB) implemented as an electronic whiteboard capable of performing interactive communication, an output device such as digital signage, a head-up display (HUD), an industrial machine, an imaging device, a sound collecting device, a medical device, a network home electric appliance, a connected car, a laptop PC, a mobile phone, a smartphone, a tablet terminal, a game console, a personal digital assistant (PDA), a digital camera, a wearable PC, or a desktop PC, for example.

The present invention is applicable to two devices communicable with each other via a plurality of different communication channels. The communication method employed in the communication channels is not limited to a particular method. For example, the present invention is applicable to two devices communicable with each other via two independent wired communication channels: a first wired communication channel for transmitting and receiving information with a first cable and a second wired communication channel for transmitting and receiving information with a second cable. The present invention is similarly applicable to two devices communicable with each other via two independent wireless communication channels: a first wireless communication channel and a second wireless communication channel.

In the above-described embodiment, each of the main device 100A and the control device 100B includes a single CPU. Alternatively, each of the main device 100A and the control device 100B may include a plurality of CPUs, a plurality of ROMs, and a plurality of RAMs. In this case, the units forming the main control unit 320 illustrated in FIG. 3 may be implemented by hardware components different from each other. Further, units related to the detection of the failure of the wired communication unit 323 and a resetting unit for resetting the wired communication unit 323 and units related to the detection of the failure of the wireless communication unit 325 and a resetting unit for resetting the wireless communication unit 325 may be implemented by hardware components different from each other. For example, the communication failure detection unit 327 may be implemented by different software components, such as a wired communication failure detection unit that detects the communication failure related to the wired communication unit 323 and a wireless communication failure detection unit that detects the communication failure related to the wireless communication unit 325. Further, the wired communication failure detection unit and the wireless communication failure detection unit may be implemented by different hardware components.

The functions of the above-described embodiment may be implemented by one or more processing circuits. In the present specification, the term “processing circuit” refers to, for example, a processor programmed to execute the above-described functions with software such as a processor implemented as an electronic circuit or a device such as an application specific integrated circuit (ASIC), a digital signal processor (DSP), a field programmable gate array (FPGA), or a typical circuit module designed to execute the above-described functions.

The embodiment of the present invention may be implemented as follows. In the following description, the main device 100A and the control device 100B are given as an example of an information processing apparatus and an example of another information processing apparatus, respectively, but are interchangeable. Similarly, the wired communication channel 10 and the wireless communication channel 20 are given as an example of the first communication channel and an example of the second communication channel, respectively, but are interchangeable.

In the embodiment, an information processing apparatus (i.e., the main device 100A) transmits and receives information to and from another information processing apparatus (i.e., the control device 100B). The information processing apparatus (i.e., the main device 100A) includes the first communication device (i.e., the wired communication unit 323), the second communication device (i.e., the wireless communication unit 325), and circuitry (i.e., the resetting unit 326). The first communication unit transmits and receives the information to and from the another information processing apparatus via the first communication channel (i.e., the wired communication channel 10). The second communication unit transmits and receives the information to and from the another information processing apparatus via the second communication channel (i.e., the wireless communication channel 20). The circuitry resets the first communication device while maintaining communication between the information processing apparatus and the another information processing apparatus via the second communication channel.

According to the embodiment, when the communication via the first communication channel fails, the circuitry (i.e., the resetting unit 326) executes the resetting process specifically on the first communication device while maintaining the communication via the second communication channel. Since the communication via the second communication channel is maintained during the resetting of the first communication device, the first communication device is restored without compromise of the user operability and convenience. The embodiment further improves the failure resilience of a system including the plurality of information processing apparatuses.

In the information processing apparatus (i.e., the main device 100A), the first communication device (i.e., the wired communication unit 323) includes the first communication interface circuit (i.e., the wired I/F circuit 107) and the first communication controller (i.e., the wired I/F control unit 322). The first communication interface circuit generates a signal related to the information transmitted and received to and from the another information processing apparatus (i.e., the control device 100B) via the first communication channel (i.e., the wired communication channel 10). The first communication controller controls the first communication interface circuit, and is implemented by the circuitry.

According to the embodiment, the first communication device includes a circuit and a controller therefor. When resetting the first communication device, the circuitry (i.e., the resetting unit 326) resets both the circuit and the controller therefor, providing the above-described effects.

In the information processing apparatus (i.e., the main device 100A), when a communication failure occurs (i.e., is detected) in the first communication channel (i.e., the wired communication channel 10), the circuitry (i.e., the resetting unit 326) resets the first communication device (i.e., the wired communication unit 323).

When the circuitry (i.e., the communication failure detection unit 327) detects the occurred communication failure, the circuitry (i.e., the resetting unit 326) resets the first communication device.

In the information processing apparatus (i.e., the main device 100A), the circuitry (i.e., the resetting unit 326) resets the first communication device (i.e., the wired communication unit 323) when the information processing apparatus (i.e., the main device 100A) is not being used.

The circuitry (i.e., the use state determination unit 330) determines the use state of the information processing apparatus (i.e., the main device 100A) based on information such as the detection information received from the sensor 113. For example, the sensor 113 may be implemented as an illuminance sensor that detects the brightness around the information processing apparatus or a human sensor that detects a human body present near the information processing apparatus. When the brightness detected by the illuminance sensor is less than a predetermined value, or when no human body is detected by the human sensor, the circuitry (i.e., the use state determination unit 330) may determine that the information processing apparatus is not currently being used. Further, when the operation panel 110 of the information processing apparatus is not being operated by the user, the circuitry (i.e., the use state determination unit 330) may determine that the information processing apparatus is not currently being used.

The process of resetting the first communication device and restoring the first communication channel takes a certain time. According to the embodiment, when the information processing apparatus is not being used by the user, the process of resetting the first communication device and restoring the first communication channel is executed. Thereby, the communication disruption time during the use of the information processing apparatus is minimized, thereby improving the user convenience.

In the information processing apparatus (i.e., the main device 100A), when the communication failure occurs (i.e., is detected) in the first communication channel (i.e., the wired communication channel 10), the circuitry (i.e., the connection management unit 321) switches from the first communication device (i.e., the wired communication unit 323) to the second communication device (i.e., the wireless communication unit 325) to transmit and receive the information to and from the another information processing apparatus (i.e., the control device 100B).

When the circuitry (i.e., the communication failure detection unit 327) detects the occurred communication failure, the circuitry (i.e., the connection management unit 321) switches from the first communication device to the second communication device to transmit and receive the information to and from the another information processing apparatus.

According to the embodiment, even if the communication failure occurs in the first communication channel, the communication with the another information processing apparatus (i.e., the control device 100B) is maintained via the second communication channel, thereby improving the user operability and convenience and the failure resilience of the system including the plurality of information processing apparatuses.

In the information processing apparatus (i.e., the main device 100A), the circuitry (i.e., the connection management unit 321) temporarily switches from the first communication device (i.e., the wired communication unit 323) to the second communication device (i.e., the wireless communication unit 325) at a certain time to transmit and receive the information to and from the another information processing apparatus (i.e., the control device 100B).

To maintain the communication between the information processing apparatus (i.e., the main device 100A) and the another information processing apparatus (i.e., the control device 100B) in the event of a communication failure in the first communication channel, the communication unit that transmits and receives the information to and from the another information processing apparatus is switched to the second communication device. When the communication unit is thus switched to the second communication device, the second communication device is expected to normally operate such that the communication via the second communication channel is reliably executed. According to the embodiment, the communication unit that transmits and receives the information to and from the another information processing apparatus is temporarily switched to the second communication device at a certain time to check if the second communication device normally operates.

As described above, according to the embodiment, the normal operation of the second communication device is ensured even if the communication is normally performed with the first communication device. If the communication failure occurs in the second communication channel when the first communication device is temporarily switched to the second communication device, the circuitry (i.e., the resetting unit 326) resets the second communication device to restore the second communication channel to the normal state. Consequently, the communication via the second communication channel is reliably executed in the event of a communication failure in the first communication channel, thereby improving the user convenience.

In the information processing apparatus (i.e., the main device 100A), the circuitry (i.e., the failure counting unit 328) counts the number of occurrences (i.e., detections) of the communication failure in the first communication channel (i.e., the wired communication channel 10). When the counted number of occurrences (i.e., detections) of the communication failure in the first communication channel reaches a certain value, the circuitry (i.e., the connection management unit 321) sets the second communication device (i.e., the wireless communication unit 325) to transmit and receive the information to and from the another information processing apparatus the control device 100B) at the next start-up of the information processing apparatus (i.e., the main device 100A).

The circuitry (i.e., the failure counting unit 328) counts the number of occurrences (i.e., detections) of the communication failure detected by the circuitry (i.e., the communication failure detection unit 327).

If the communication failure frequently occurs in the first communication channel when the first communication device is set as the communication unit that transmits and receives the information to and from the another information processing apparatus (i.e., the control device 100B) at the start-up of the information processing apparatus (i.e., the main device 100A), the communication failure may occur again, resulting in the switch to the second communication device as the communication unit that transmits and receives the information to and from the another information processing apparatus.

According to the embodiment, when the number of occurrences (i.e., detections) of the communication failure reaches a certain value, the communication unit that transmits and receives the information to and from the another information processing apparatus (i.e., the control device 100B) at the next start-up of the information processing apparatus (i.e., the main device 100A) is previously set to the second communication device. The embodiment thereby prevents a failure such as communication disruption due to the communication failure of the first communication channel.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above-described steps are not limited to the order disclosed herein.

1. An information processing apparatus comprising:
a first communication device configured to transmit and receive the information to and from another information processing apparatus via a first communication channel;
a second communication device configured to transmit and receive the information to and from the another information processing apparatus via a second communication channel; and
circuitry configured to reset the first communication device while maintaining communication between the information processing apparatus and the another information processing apparatus via the second communication channel.

2. The information processing apparatus of claim 1, wherein the first communication device includes
a first communication interface circuit configured to generate a signal related to the information transmitted and received to and from the another information processing apparatus via the first communication channel, and
a first communication controller implemented by the circuitry and configured to control the first communication interface circuit.

3. The information processing apparatus of claim 1, wherein when a communication failure occurs in the first communication channel, the circuitry resets the first communication device.

4. The information processing apparatus of claim 1, wherein when the information processing apparatus is not being used, the circuitry resets the first communication device.

5. The information processing apparatus of claim 1, wherein when a communication failure occurs in the first communication channel, the circuitry switches from the first communication device to the second communication device to transmit and receive the information to and from the another information processing apparatus.

6. The information processing apparatus of claim 1, wherein the circuitry temporarily switches from the first communication device to the second communication device at a certain time to transmit and receive the information to and from the another information processing apparatus.

7. The information processing apparatus of claim 1, wherein the circuitry counts a number of occurrences of a communication failure in the first communication channel, and
wherein when the counted number of occurrences of the communication failure reaches a certain value, the circuitry sets the second communication device to transmit and receive the information to and from the another information processing apparatus at next start-up of the information processing apparatus.

8. The information processing apparatus of claim 1, wherein the first communication channel is a wired communication channel, and the second communication channel is a wireless communication channel.

9. A system comprising:
the information processing apparatus of claim 1; and
the another information processing apparatus.

10. A control method executed by an information processing apparatus,
the information processing apparatus including
a first communication device configured to transmit and receive information to and from another information processing apparatus via a first communication channel, and
a second communication device configured to transmit and receive the information to and from the another information processing apparatus via a second communication channel, and
the control method comprising:
resetting the first communication device while maintaining communication between the information processing apparatus and the another information processing apparatus via the second communication channel.

11. The control method of claim 10, further comprising:
using the first communication device, generating a signal related to the information transmitted and received to and from the another information processing apparatus via the first communication channel.

12. The control method of claim 10, further comprising:
determining whether a communication failure occurs in the first communication channel; and
when the determining determines that the communication failure occurs in the first communication channel, resetting the first communication device.

13. The control method of claim 10, further comprising:
determining whether the information processing apparatus is not being used; and
when the determining determines that the information processing apparatus is not being used, resetting the first communication device.

14. The control method of claim 10, further comprising:
determining whether a communication failure occurs in the first communication channel; and
when the determining determines that the communication failure occurs in the first communication channel, switching from the first communication device to the second communication device to transmit and receive the information to and from the another information processing apparatus.

15. The control method of claim 10, further comprising:
temporarily switching from the first communication device to the second communication device at a certain time to transmit and receive the information to and from the another information processing apparatus.

16. The control method of claim 10, further comprising:
counting a number of occurrences of a communication failure in the first communication channel; and
when the counted number of occurrences of the communication failure reaches a certain value, setting the second communication device to transmit and receive the information to and from the another information processing apparatus at next start-up of the information processing apparatus.

17. A non-transitory recording medium storing a plurality of instructions which, when executed by one or more processors, cause the processors to perform a control method executed by an information processing apparatus,
the information processing apparatus including
a first communication device configured to transmit and receive information to and from another information processing apparatus via a first communication channel, and
a second communication device configured to transmit and receive the information to and from the another information processing apparatus via a second communication channel, and
the control method comprising:
resetting the first communication device while maintaining communication between the information processing apparatus and the another information processing apparatus via the second communication channel.
